(19) United States
(12) Patent Application Publication
(10) Pub. No.: US 2017/0030576 A1
(43) Pub. Date: Feb. 2, 2017

(54) CANDLE CONTAINER SYSTEM

(71) Applicant: Jean Ronald Brisard, Englewood, NJ (US)

(72) Inventor: Jean Ronald Brisard, Englewood, NJ (US)

(21) Appl. No.: 14/810,688

(22) Filed: Jul. 28, 2015

(51) Int. Cl. F21V 35/00; F23D 3/16

(52) U.S. Cl. CPC F21V 35/006; F23D 3/16

(57) ABSTRACT

A candle container system comprising one or more openings that convey water out of the container and a raised surface configured to extinguish a candle prior to the hot wax being able to flow out the one or more openings and a method of manufacturing a candle container.

Additionally, a support system for adding a chimney to a container and candle combination in a predetermined relationship with respect to container and candle combination.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD

The present application relates to candles.

### BACKGROUND

Current containers used for candles, particularly those used outdoors and especially those with insect repellant prosperities, such as citronella candles, have a serious drawback. When rain water (or water from other source such as sprinkler systems or a garden hose) fall into the container, the water seeps down gaps between the candle and the inside walls of the container and settles in the bottom of the container. The stagnant water then reacts with the wax and degrades the ingredients in the mixture and, in the case of insect repellant candles, degrades the candles effectiveness at repelling insects by altering the active ingredients in the mix, which may, leach into the standing water or otherwise be disturbed.

In addition, the standing water may, in the case of an untreated metal container, quickly corroded the container and produce structural deficiencies, such as holes through which the molten wax leaks out and damages and stains the surface on which the container is standing.

Finally, the standing water may become stagnant and as a result can become very fowl smelling.

Therefore, there continues to be a need for an effective means of removing any water that falls into a container containing a candle.

### SUMMARY

In order to overcome the deficiencies in the prior art, systems and methods are described herein.

One aspect of the claimed invention involves a candle container system comprising one or more openings that are able to convey water out of the container and a raised surface with the container that is configured to extinguish the candle when the melt pool associated with the candle is a predetermined distance from the one or more openings.

Another aspect involves a system of adding a chimney to a container and candle combination comprising a chimney and a support structure for the chimney that is configured to support the chimney in a predetermined relationship with respect to container and candle combination.

An additional aspect involves a method of manufacturing a candle container comprising placing one or more openings in the container that are configured to convey water out of the container and creating a raised surface associated with the container that is configured to the extinguish a candle burning such that the melt pool of the candle remains at least a predetermined distance away from the one or more openings.

These and other aspects described herein present in the claims result in features and/or can provide advantages over current technology.

The advantages and features described herein are a few of the many advantages and features available from representative embodiments and are presented only to assist in understanding the invention. It should be understood that they are not to be considered limitations on the invention as defined by the claims, or limitations on equivalents to the claims. For instance, some of these advantages or features are mutually exclusive or contradictory, in that they cannot be simultaneously present in a single embodiment. Similarly, some advantages are applicable to one aspect of the invention, and inapplicable to others. Thus, the elaborated features and advantages should not be considered dispositive in determining equivalence. Additional features and advantages of the invention will become apparent in the following description, from the drawings, and from the claims.

### BRIEF DESCRIPTION OF THE DRAWINGS

FIG. 1 shows, in simplified form, a cross section of a candle container for allowing water to exit;

FIG. 2 shows, in simplified form, an alternate configuration;

FIGS. 3A-D shows, in simplified form, a cross section of an under wicked candle;

FIGS. 4A-D shows, in simplified form a cross section of a properly wicked candle;

FIGS. 5A-D shows, in simplified form, a cross section of an over wicked candle;

FIG. 6 shows, in simplified form, a cross section of conical chimney added as lid that fits over the container;

FIG. 7 shows, in simplified form, the use of adjustable supports added to modified container to support a chimney;

FIG. 8 shows, in simplified form, an extendable support that clamps onto the side of container;

FIG. 9, shows, in simplified form a floating chimney support that floats on top of the melt pool;

FIG. 10 shows, in simplified form, floating support structures that sinks to the bottom of the melt pool.

### DETAILED DESCRIPTION

The instant devices and approach provide a way to effectively remove water that enters a container that houses a candle without allowing the melted portion of the candle, the “melt pool”, to flow out of the container.

The approach involves creating a container having one or more openings that allows water that seeps between the candle and the inside walls of the container to exit the container and creating a raised surface associated with the container that is configured to the prevent the candle from burning beyond the point that the melt pool of a candle will run out the one or more openings.

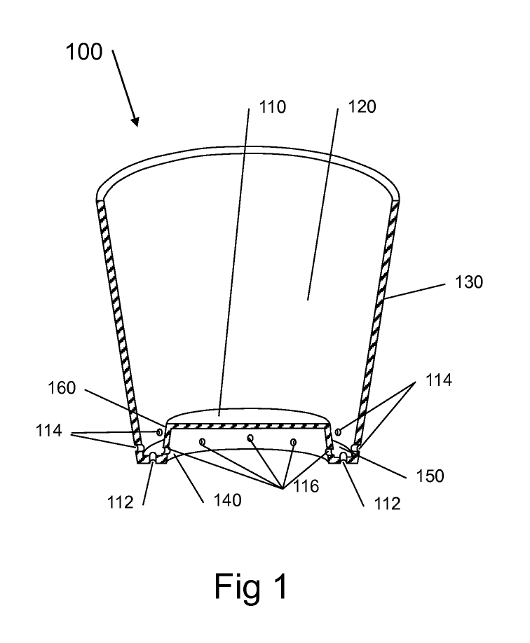

FIG. 1 shows, in simplified form, a cross section of a candle container 100 for allowing water to exit. It show a container with a contiguous raised surface 110 with one or more openings (holes) 112, 114, 116 configured to allow water to exit from the container. The container has an interior surface 120, one or more sides 130,140 and a bottom 150 and the raised surface 110 has one or more sidewalls 160 associated it. Additionally the one or more openings convey water out of one or more of either the bottom 150 or one of the sides 130, 140 that may or may not be associated with the sidewalls 160.

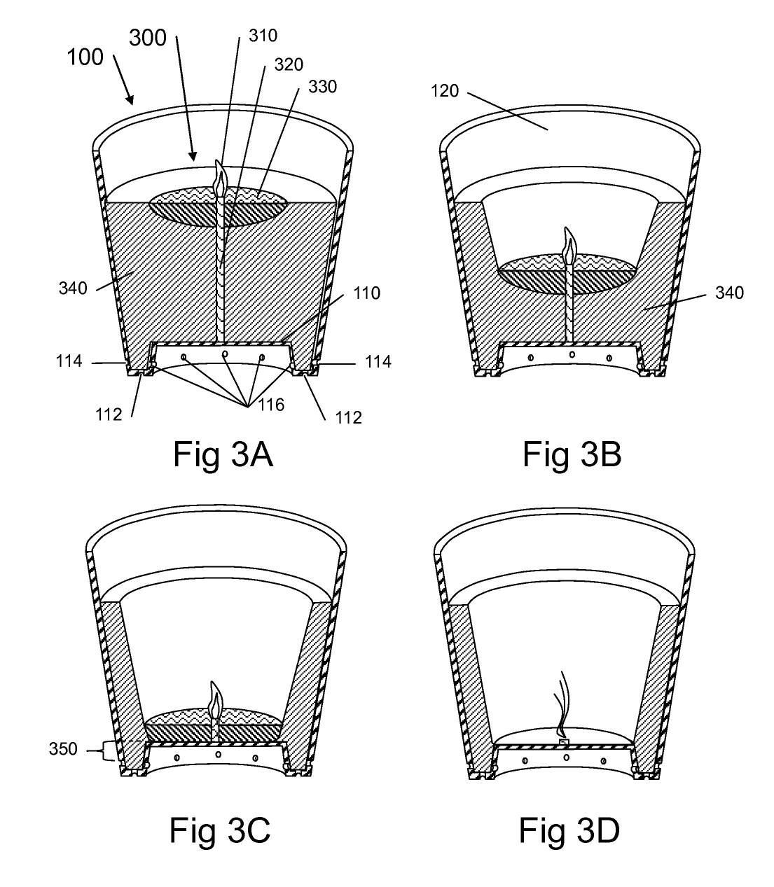

As pictured, the container is substantially cylindrical with angled sides 130, 140. As such, the sides 130, 140 are represented as a single surface but the container could be made up a plurality of surfaces that could be standard shapes such as spherical, cube, cuboid, triangular prism, hexagonal prism, octagonal prism . . . etc. and even non-standard shapes, for example it could even be shaped like a duck or a bust of President Obama. The point being not the particular shape but that there is both a raised surface and one or more openings that allow water to exit and that there is a relationship between the raised surface and the one or more openings that allows water to exit without allowing the melt pool of the candle to flow out of the openings, which will be elaborated on with respect to FIG. 3A-D, 4A-D, and 5A-D.

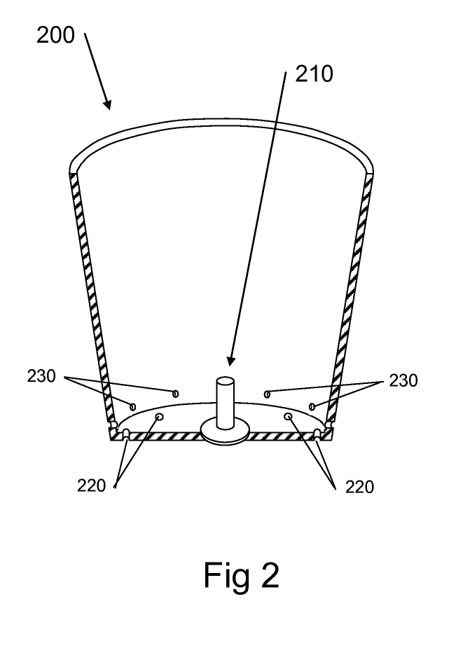

FIG. 2 shows, in simplified form, an alternate configuration. In this configuration, instead of the raised surface being contiguous with the container 200, it shows the raised surface as a separate component 210 and the container having one or more openings 220,230 similarly configured to allow water to exit from the container.

In this particular case, the raised surface 210 is shown as a wick stand, which is a component designed to hold the wick of a candle and not allow the candle to burn past the top of the wick stand, since the candle is unable to get any fuel once the wick stand is reached. The wick stand may be a component either directly associated with the container or indirectly associated with the container as a component integral to the candle inserted into the container.

The point being not the type of association that the raised surface has with the container (nor its specific shape) but that there is both a raised surface associated with the container and that there is a relationship between the raised surface and the one or more openings that allows water to exit without allowing the melt pool associated of the candle to flow out of the openings, which will be elaborated on with respect to FIG. 3A-D, 4A-D, and 5A-D.

When a candle burns the heat from the flame melts some of the candle in the immediate vicinity of the flame into a liquid pool called a melt pool. This melt pool provides fuel for the candle to continue burning and the candle will continue to burn as long as the melt pool is capable of providing fuel. [Note: the discussion of candle burning within the container that follows references the container 100 from FIG. 1. However, it is just as applicable to container 200 of FIG. 2, and any variation thereof, as well.]

One of the most important aspects of candle making is choosing the right wick size for your candle. A properly wicked candle burns cleaner, and gives reliable burn times and provides uniform disbursement of any fragrance, such as an insect repellant.

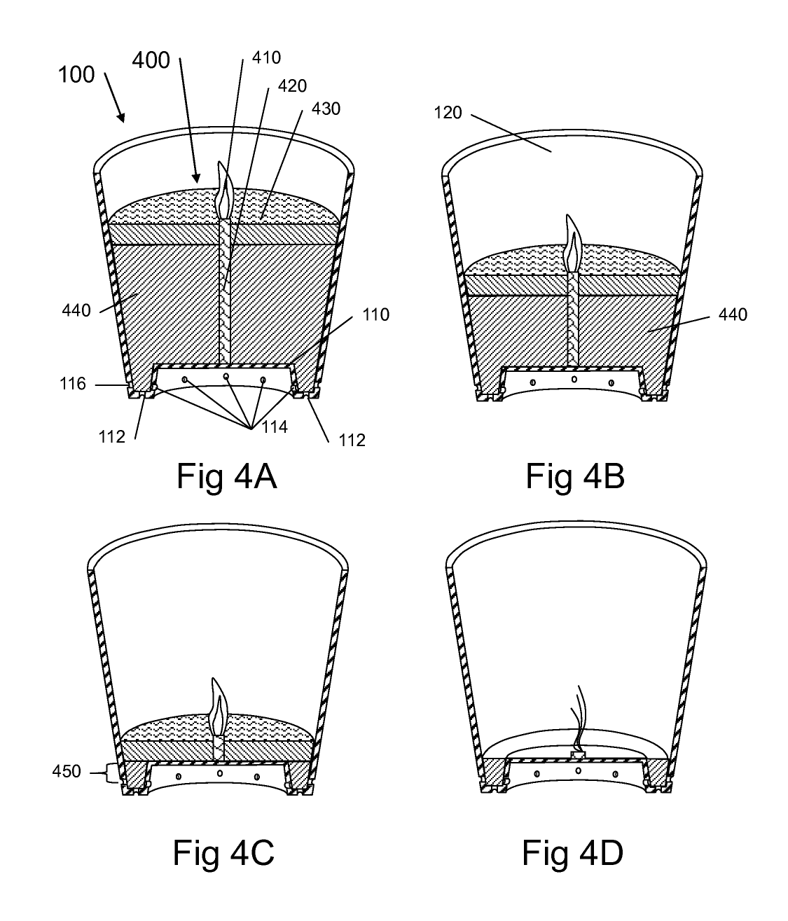

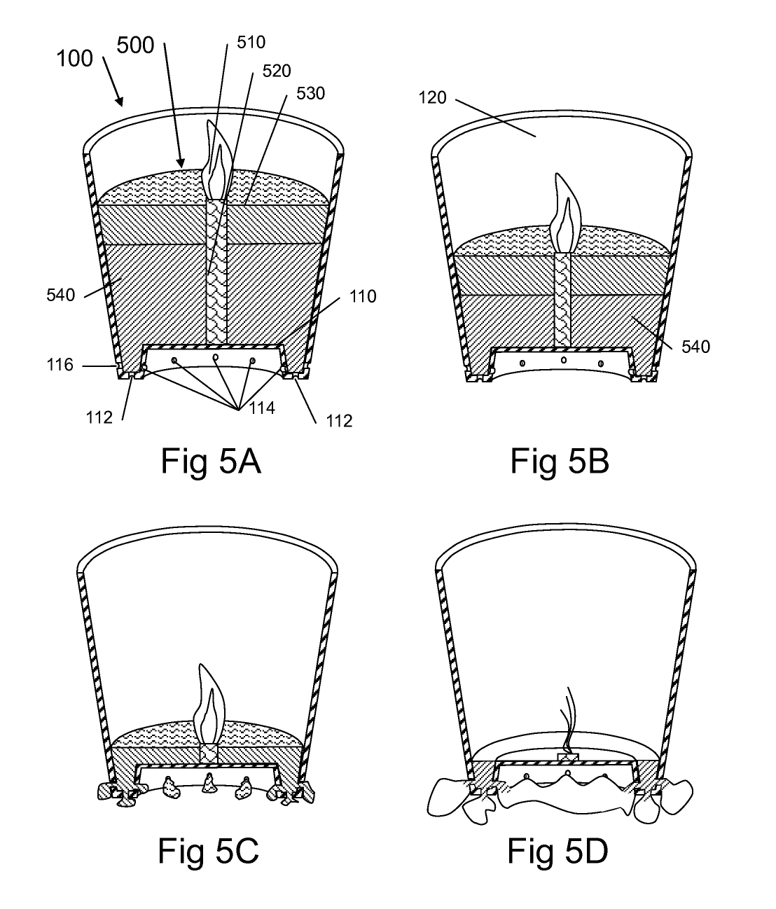

Candles can either be under wicked as in FIGS. 3A-D, properly wicked as in FIGS. 4A-D, or over wicked as in FIGS. 5A-D. The way a candle burns is a function of the wick size; the type of fuels (e.g. wax) selected; any additives, such as color and or fragrances; and even the ambient temperature. The depth of the melt pool can either be calculated based on thermodynamic principles or simply determined based upon experimentation.

An under wicked candle will not burn out to the edge of the container but will instead burn down the middle, or ‘tunnel’ and the wick may extinguish itself before all the wax is burned.

FIGS. 3A-D shows, in simplified form, a cross section of an under wicked candle. In FIGS. 3A-D, the container 100 from FIG. 1, has a candle 300 inside it. The candle 300 could either have been formed directly in container 100 by initially plugging the one or more holes 112, 114, 116 or placed into the container 100 as a separate item. The wick 310 of candle 300 has been lit and the heat from flame 320 on top of the wick 310 has created a melt pool 330 of liquid candle material that acts as fuel. As more of the candle 300 burns additional portions of the solid candle 340 is converted into the melt pool 330.

FIG. 3A represents a candle 300 that was recently lit and a melt pool 330 has formed.

In FIG. 3B we see the candle 300 is approximately half way burned down and the under wicked, as the melt pool does not extend all the way to the interior surface 120 of the container 100, it can be seen that tunneling is occurring and that solid candle material 340 is left on the sides.

In FIG. 3A, the melt pool 330 has reached the top of the raised surface 110 and the candle 300 is able to continue to burn because it is still able to acquire fuel from the melt pool 330.

In FIG. 3D we see that the candle has continued to consume all of the available fuel from the melt pool and the flame 320 has gone out. The lower limit of the melt pool 330, should always be a predetermined distance 350, preferably at least one of either 1/16, ⅛, ¼, or ½″ above the nearest one or more opening 112, 114, 116.

For a properly wicked candle (see FIGS. 4A-D), the flame is appropriately sized and does not flicker. The melt pool has extended to the interior surface of the container, and is about ½ inch deep or other predetermined depth. The wick is burning cleanly without any carbon build up.

FIGS. 4A-D shows, in simplified form, a cross section of a properly wicked candle. In FIGS. 4A-D, the container 100 from FIG. 1, has a candle 400 inside it. The candle 400 could either have been formed directly in container 100 by initially plugging the one or more holes 112, 114, 116 or placed into the container 100 as a separate item. The wick 410 of candle 400 has been lit and the heat from flame 420 on top of the wick 410 has created a melt pool 430 of liquid candle material that acts as fuel. As more of the candle 400 burns additional portions of the solid candle 440 is converted into the melt pool 430.

FIG. 4A represents a candle 400 that was recently lit and a melt pool 430 extends all the way to the interior surface 120 of the container 100 and the depth of the melt pool 435 is approximately ½ an inch deep, or other predetermined value.

In FIG. 4B it can be seen that the candle is approximately half way burned down and that the melt pool continues to extend all the way to the interior surface 120 of the container 100.

In FIG. 40, the melt pool 430 has reached the top of the raised surface 110 and the candle 400 is able to continue to burn because it is still able to acquire fuel from the melt pool 430.

In FIG. 4D we see that the candle has continued to consume all of the available fuel from the melt pool and the flame 420 has gone out. The lower limit of the melt pool 430, should always be a predetermined distance 450, preferably at least one of either 1/16, ⅛, ¼, or ½″ above the nearest one or more opening 112, 114, 116.

If the candle is over wicked (see FIGS. 5A-D) then the flame of the candle will be too large and will continuously flicker and throw off excess carbon. In such a case, the melt pool is typically deeper than desired predetermined depth of typically about a ½ inch, and often the excess carbon at the end of the wick will fall off into the melt pool. In an over wicked candle, wisps of soot can be seen leaving the flame periodically, which may produce a buildup of soot on the inside of the container. Additionally, an over wicked container may become very hot and could damage the surface that the container rests on or may even crack the surface or the container.

FIGS. 5A-D shows, in simplified form, a cross section of an over wicked candle. In FIGS. 5A-D, the container 100 from FIG. 1, has a candle 500 inside it. The candle 500 could either have been formed directly in container 100 by initially plugging the one or more holes 112, 114, 116 or placed into the container 100 as a separate item. The wick 510 of candle 500 has been lit and the heat from flame 520 on top of the wick 510 has created a melt pool 530 of liquid candle material that acts as fuel. As more of the candle 500 burns additional portions of the solid candle 540 is converted into the melt pool 530.

FIG. 5A represents a candle 500 that was recently lit and a melt pool 530 has formed the candle recently lit and it can be seen that the melt pool extends all the way to the interior surface 120 of the container 100 and the depth of the melt pool 535 exceeds the desired predetermined depth (typically of approximately ½ an inch deep).

In FIG. 5B it can be seen that the candle approximately half way burned down and that the melt pool continues to extend all the way to the interior surface 120 of the container 100.

In FIG. 5C it can be seen that an undesirable situation has occurred where the candle was over wicked and instead of insuring that the lower limit of the melt pool 530, always remained a predetermined distance above the nearest one or more opening 112, 114, 116, the melt pool has been able to reach the one or more openings and the melt pool 530 is beginning to spill out of the one or more openings 112, 114, 116.

In FIG. 5D we see even more of the melt pool has spilled out of the one or more opening 112, 114, 116 and all of the available fuel has been consumed and the flame 520 has gone out.

In order to avoid the situation specified in FIGS. 5A-D, it is important to insure that the raised surface insures that all the fuel accessible to the candle is consumed and the candle is extinguished prior to the melt pool reaching the one or more openings that allow water to flow out of the container.

When water enters the container, there should always be a pathway for water to seep between the container and the candle. If the candle was formed inside the container than the natural cooling process of the candle material poured into the container will cause a contraction in the containers volume that will cause it to naturally pull away from the containers walls and create a pathway that allow water to seep down and out the one or more openings of the container. However, the pathway should not be so large that it allows the melt pool to reach the one or more openings.

In the case where the candle is separately inserted into the container the interior surface of the container should be configured to substantially conform to the shape of the candle such that there are still pathways for water to flow between the interior surface of the container and the candle and out the one or more openings but are not sufficiently large to allow the melt pool to do the same.

In the event that that the candles 300, 400, 500 of FIGS. 3A-C, 4A-C, or 5A-C is extinguished at an intermediate stages then as the melt pool cools it will reform into a solid. In the case of FIGS. 4A-C or 5A-C, where the melt pool previously extended all the way to the interior surface there will initially be a path for water to flow. However, as the melt pool reforms a solid its volume will contract slightly creating a slight gap between the candles 400, 500 and the container 100. This gap will allow any water that enters into the container to seep between the container and the candle and exit out the one or more holes 112, 114, 116.

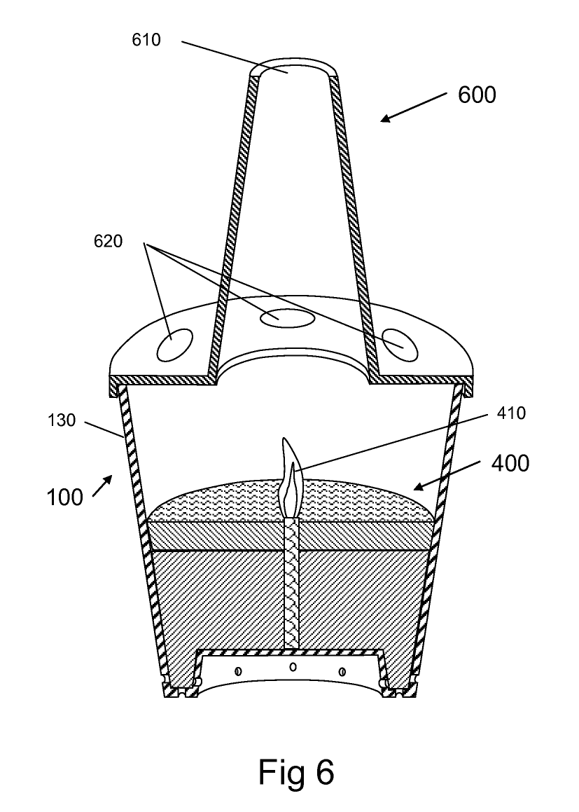

Aside from the properties associated with the candle such as wick size, fuel type, additives . . . etc., the geometry of the container and specifically any incorporated chimneying and or air intake may affect the flame characteristics and thereby affect the depth of the melt pool. Chimneys, and associated air intake, can either be incorporated into the container itself, added as a separate component that is either attached too or supported by the container, or supported by the candle itself. As such, several representative ways of incorporating a chimney will be discussed with reference to FIGS. 6-10. [Note: that while the incorporation of a chimney is discussed with reference to container 100 of FIG. 4B, it is just as applicable to container 200 of FIG. 2, and any variation thereof, as well.] The important aspect being that chimneying, and associated air intake, if incorporated needs to be taken into account when determining the depth of the melt pool, which can either be calculated based on thermodynamic principles or simply determined based upon experimentation.

FIG. 6 shows, in simplified form, a cross section of conical chimney 600 added as lid that fits over the container 100 of FIG. 4B, which shows candle 400 in a state of being approximately half way burned down. The lid and chimney are advantageously incorporated as to separate pieces to facilitate lighting of the candle but could also be incorporated directly into the container itself, as a previously specified non-standard shape.

In order for the flame 410 to burn, it must be able to get a supply of air that can either come directly from the chimney vent 610 at the top of the chimney, in which case the air will both enter and exit through chimney vent 610 or through one or more separate air intake vents 620, which may be a part of the lid/chimney, as shown, or alternatively incorporated into the sides 130 of the container, not shown. The air intake vents 620 may be simple openings or closeable apertures (e.g. louvered) that allows the amount of air coming into to be adjusted.

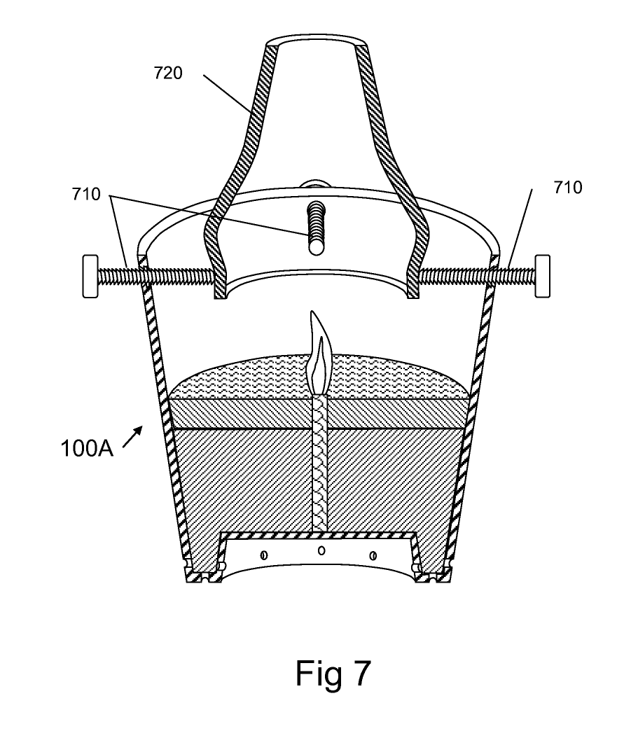

FIG. 7 shows, in simplified form, the use of adjustable supports 710 added to modified container 100A of FIG. 4B to support a chimney. The chimney in this case is a sconce 720, which is shown in cross section. Sconces are available in numerous designs sizes, shapes, colors, and even material choices, such as glass or plastics. In addition, custom sconces are also anticipated.

The adjustable supports 710 are adjusted in order to hold the sconce 720 in place and air intake occurs between the modified container 100A and the sconce 720.

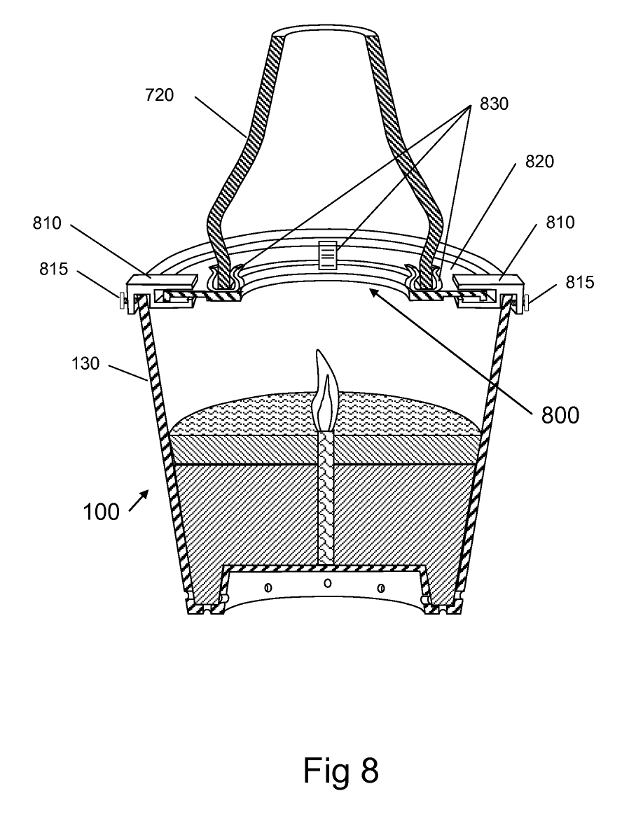

While FIG. 7 showed an adaptation to a container in order to support a chimney, an alternatively approach will be discussed in FIG. 8, which is useful with/without features specified in FIG. 1 of raised support 110 and one or more openings 112, 114,116 (and similarly for FIG. 2). The alternate approach is to add a chimney to an existing containers and is therefore applicable to candles in containers in general using an extendable chimney support mechanism that attaches over the top or the container by gripping onto the sides of the container, or engaging with a container lip, if present.

FIG. 8 shows, in simplified form, an extendable chimney support 800 that attaches onto the side 130 of container 130 of FIG. 4B. The particular manner of attachment shown is shown as a set screw but other temporary techniques such as spring loaded locking mechanisms; simple fits, such as a slip, interference and press fits and/or permanent attachment means such as solvent bonding and welding are also anticipated. The point being not the particular manner of attachment but the attachment is configured to support the chimney at a predetermined distance above or below the top of the container.

The extendable chimney support 800 as shown has at least one adjustable arm 810 to fit various container diameters and support a chimney, which in this case is shown in cross section as a sconce 720, at a predetermined height in relationship to the container.

The predetermined height in relationship to the container 100 and the bottom of the sconce 720 is shown as approximately even with the top of the container 100. However, raised and/or lowered relationships are also anticipated based on either one or more of the adjustable arm 810 or the chimney platform 820 incorporating an offset. Additionally, in order to raise the chimney various heights of chimney mounts 830 are also anticipated

In FIG. 8, the air intake occurs between the container 100 and chimney platform 810 but depending on the chimney mounts 830 may also occur between the sconce 720 and the chimney platform 820 as well. It should also be noted that chimney platform 820 need not be solid (as shown) and additional configurations such as a mesh configurations that advantageously provide additional air intake are anticipated.

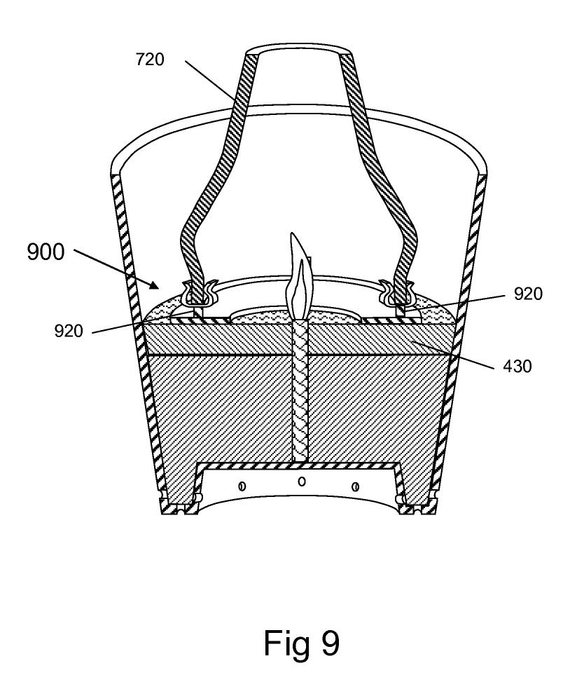

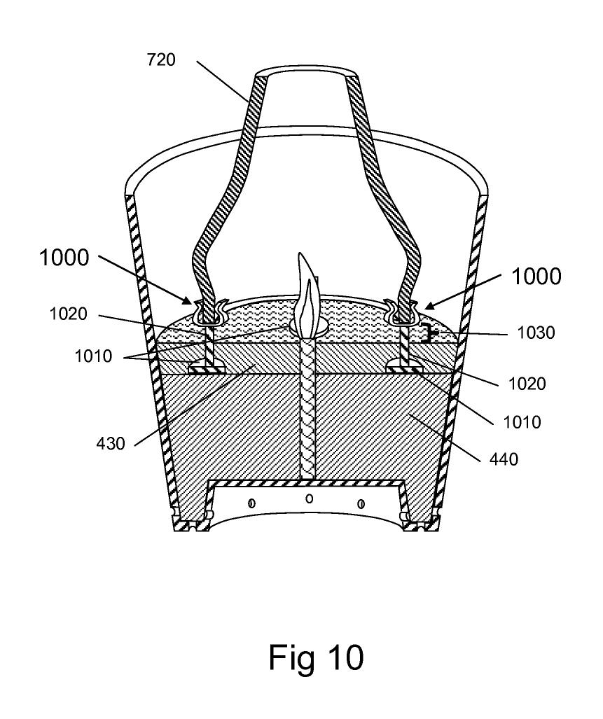

Up to this point, representative embodiments of supporting a chimney based to one degree or another by the container have been presented. However, the chimney can also be supported by the candle itself, which will now be discussed. It should also be noted that similar to FIG. 8 the embodiments discussed in FIG. 9-10 are useful with/without features specified in FIG. 1 of raised support 110 the raised supports one or more openings 112, 114,116 (or similarly if FIG. 2) and are therefore applicable to candles in containers in general.

The simplest way for the candle to support a chimney is to imbed a support structure directly into the candle that runs from top to bottom of the candle.

However, a more advantageous approach is to incorporate a floating support structure that either floats on top of the melt pool or sinks into the melt pool and rests on the bottom of the melt pool and as a result floats within the candle. In either case, the supports are designed to maintain a predetermined relationship between the candle and the chimney.

FIG. 9, shows, in simplified form a floating chimney support 900 that floats on top of the melt pool 430 of FIG. 4B. The floating chimney support 900 is sufficiently buoyant to support both its weight and that of the chimney, which in this case is shown in cross section as a sconce 720. The air intake is between the sconce 720 and the floating chimney support 900, due to the offset posts 920.

FIG. 10 shows, in simplified form, floating support structures 1000 that sinks to the bottom of the melt pool 430 of FIG. 4B. However, unlike FIG. 9, the floating support structures 1000 of FIG. 10 is not buoyant enough to float on top of the melt pool 430 and instead sink through it and the pads 1010 rest on the bottom of the solid portion of the candle 440. The floating support structures 1000 has chimney support arms 1020 that are advantageously configured to extend a predetermined distance 1030 above the top of the melt pool and thereby allows air intake to occur between the melt pool 430 and the sconce 720 shown in cross section. The floating chimney supports 1000 and the sconce 720 are show as separate entities but connected entities are also envisioned.

Finally, it is to be understood that various different variants of the invention, including representative embodiments and extensions have been presented to assist in understanding the invention. It should be understood that such implementations are not to be considered limitations on either the invention or equivalents except to the extent they are expressly in the claims. It should therefore be understood that, for the convenience of the reader, the above description has only focused on a representative sample of all possible embodiments, a sample that teaches the principles of the invention. The description has not attempted to exhaustively enumerate all possible permutations, combinations or variations of the invention, since others will necessarily arise out of combining aspects of different variants described herein to form new variants, through the use of particular hardware or software, or through specific types of applications in which the invention can be used. That alternate embodiments may not have been presented for a specific portion of the description, or that further undescribed alternate or variant embodiments may be available for a portion of the invention, is not to be considered a disclaimer of those alternate or variant embodiments to the extent they also incorporate the minimum essential aspects of the invention, as claimed in the appended claims, or an equivalent thereof.

What is claimed:

1. A candle container system comprising:
a container having an interior surface and also one or more openings, wherein the one or more openings are configured to convey water that is able to pass between a candle and the interior surface of the container out of the container and
a raised surface associated with the container that is configured to the prevent the candle, when burning inside the container, from acquiring any more fuel from a melt pool associated with the burning candle once the candle has burned down to a predetermined height, wherein the predetermined height is such that the melt pool remains at least a predetermined distance away from the one or more openings.

2. The system of claim 1 wherein the interior surface of the container is configured to substantially conform to the shape of the candle such that the melt pool is able to extend the entire breadth of the candle and form a melt pool depth above the un-melted portion of the candle.

3. The system of claim 2, wherein the depth of the melt pool in such that the candle is a properly wicked candle.

4. The system of claim 1 wherein the raised surface is a wick stand that is integral to the candle.

5. The system of claim 1 wherein the raised surface is contiguous with the container.

6. The system of claim 1 wherein the container further comprises a bottom and the one or more openings are configured to convey water out of the bottom of the container.

7. The system of claim 1 wherein the container further comprises one more sides and the one or more openings are configured to convey water out of the sides of the container.

8. The system of claim 7 wherein the raised surface has sidewalls and the sides are associated with the sidewalls.

9. The system of claim 1 wherein the candle has insect repellant properties.

10. The system of claim 1 further comprising a chimney.

11. The system of claim 10, further comprising a support configured to support the chimney at a predetermined height in relationship to the container.

12. The system of claim 11 wherein the support is adjustable in order to accommodate various size containers.

13. The system of claim 10, further comprising a support configured to float with respect to the melt pool.

14. A system of adding a chimney to a container and candle combination comprising:
a chimney;
a support structure configured to support the chimney at a predetermined relationship with respect to the container and candle combination;

15. The system of claim 14 wherein the support structure is adjustable in order to accommodate various size container and candle combination.

16. The system of claim 14 wherein the support structure is configured to float with respect to the candle of the container and candle combination.

17. The system of claim 16 wherein the support structure is further configured to float within the candle of the container and candle combination.

18. A method of manufacturing a candle container comprising:
placing one or more openings in the container that are configured to convey water that is able to pass between a candle and the interior surface of the container out of the container and
creating a raised surface associated with the container that is configured to the prevent the candle placed in the container from acquiring any more fuel from a melt pool associated with the burning candle once the candle has burned down to a predetermined height, wherein the predetermined height is such that the melt pool remains at least a predetermined distance away from the one or more openings;

19. The method of claim 18 further comprising plugging the one or more openings and forming a candle within the container.

20. The method of claim 18 further comprising forming a candle separately and placing the candle within the container.
